(19) United States
(12) Patent Application Publication
(10) Pub. No.: US 2015/0205360 A1
(43) Pub. Date: Jul. 23, 2015

(54) TABLE TOP GESTURES FOR MIMICKING MOUSE CONTROL

(71) Applicant: Lenovo (Singapore) Pte. Ltd., Singapore (SG)

(72) Inventors: Xin Feng, Arcadia, CA (US); Paul Hilburger, Cary, NC (US)

(73) Assignee: Lenovo (Singapore) Pte. Ltd., Singapore (SG)

(21) Appl. No.: 14/159,109

(22) Filed: Jan. 20, 2014

(51) Int. Cl. G06F 3/01; G06F 3/0481

(52) U.S. Cl. CPC G06F 3/017; G06F 3/04812

(57) ABSTRACT

An aspect provides a method, including: capturing, using an image sensor of an information handling device, a user gesture input; determining, using a processor, that the user gesture input comprises an activating gesture input; capturing, using the image sensor of the information handling device, controlling gesture input of the user; detecting, within the captured controlling gesturing input, gestures provided on a surface and mimicking use of a mouse; and controlling an application running on the information handling device based on the controlling gesture input of the user. Other aspects are described and claimed.

### BACKGROUND

Information handling devices (“devices”) come in a variety of forms, for example desktop or laptop computing devices, tablet computing devices, smart phones, and the like. For certain devices, e.g., tablets, clamshell style laptop computers, desktop computers, and hybrid form factors, users may wish to employ a traditional mouse or other physical implement for providing user inputs, e.g., controlling inputs such as moving an on-screen cursor, scrolling, zooming in and out, rotating the content of the display, and/or content inputs, e.g., cut and paste actions, drawing inputs, handwriting inputs, etc.

However, in some contexts a mouse is either not available or is not particularly useful, e.g., if a device's battery is running low or the device does not support a wired or wireless mouse, etc. In such cases, a user may resort to providing touch inputs, e.g., to a touch screen or touch pad. However, there are contexts in which there is a usability benefit to offer alternative ways to mimic mouse inputs.

### BRIEF SUMMARY

In summary, one aspect provides a method, comprising: capturing, using an image sensor of an information handling device, a user gesture input; determining, using a processor, that the user gesture input comprises an activating gesture input; capturing, using the image sensor of the information handling device, controlling gesture input of the user; detecting, within the captured controlling gesturing input, gestures provided on a surface and mimicking use of a mouse; and controlling an application running on the information handling device based on the controlling gesture input of the user.

Another aspect provides an information handling device, comprising: an image sensor that captures user gesture input; a processor operatively coupled to the image sensor; a memory device that stores instructions accessible to the processor, the instructions being executable by the processor to: capture, using the image sensor, a user gesture input; determine that the user gesture input comprises an activating gesture input; capture controlling gesture input of the user; detect, within the captured controlling gesturing input, gestures provided on a surface and mimicking use of a mouse; and control an application running on the information handling device based on the controlling gesture input of the user.

A further aspect provides a product, comprising: a storage device having code stored therewith, the code being executable by a processor and comprising: code that captures, using an image sensor of an information handling device, a user gesture input; code that determines, using a processor, that the user gesture input comprises an activating gesture input; code that captures, using the image sensor of the information handling device, controlling gesture input of the user; code that detects, within the captured controlling gesturing input, gestures provided on a surface and mimicking use of a mouse; and code that controls an application running on the information handling device based on the controlling gesture input of the user.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of using table top activating and controlling gesture inputs.

FIG. 4(A-E) illustrates examples of table top activating and controlling gesture inputs.

FIG. 5(A-G) illustrates examples of table top controlling and content inputs.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

There are contexts in which there is a usability benefit to offer alternative ways to mimic inputs of a mouse or other physical input device. This could apply to a number of scenarios. For example, scenarios where this may be beneficial include but are not limited to touch enabled devices (e.g., tablet, smart phone) that do not come with a mouse; convertible or hybrid devices used in a mode in which a pointing device is not available; where a mouse/pointing device is not available at all (e.g., no dongle available, device is running out of battery, etc.) or other like scenarios.

Accordingly, an embodiment provides a user with the ability to perform gestures, e.g., table top gestures, captured by an image sensor such as a camera, which are mapped to controlling inputs and/or content inputs, e.g., as may be provided by a mouse or other physical input device such as a pen/stylus. This may be particularly useful if such camera gestures can be supported in table top surfaces, which offers more ergonomic advantages by allowing the user to perform gestures to a surface that is perpendicular to the image sensor of the device, such as a table top, as further described herein.

The illustrated example embodiments will be best understood by reference to the figures. The following description is intended only by way of example, and simply illustrates certain example embodiments.

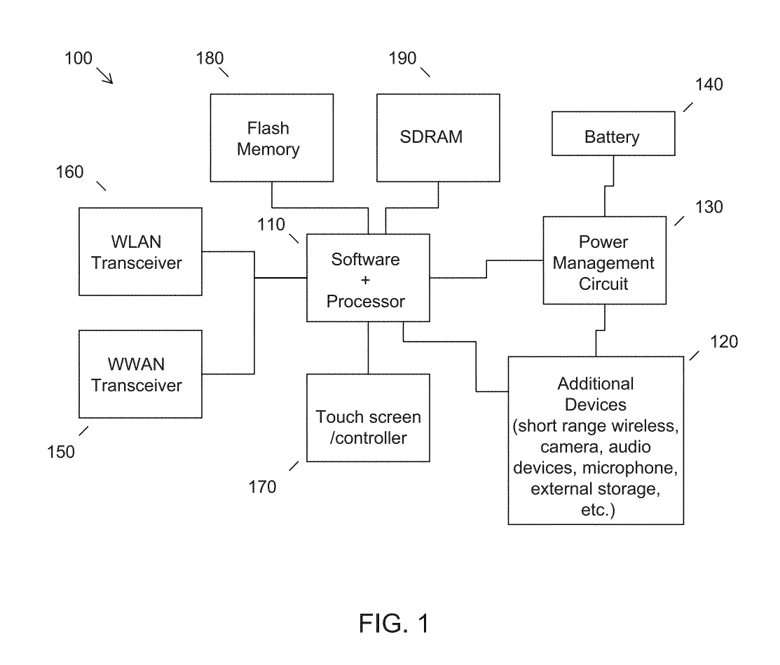

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally devices 120 are commonly included, for example an image sensor such as a camera. System 100 often includes a touch screen 170 for data input and display/rendering. System 100 also typically includes various memory devices, for example flash memory 180 and SDRAM 190.

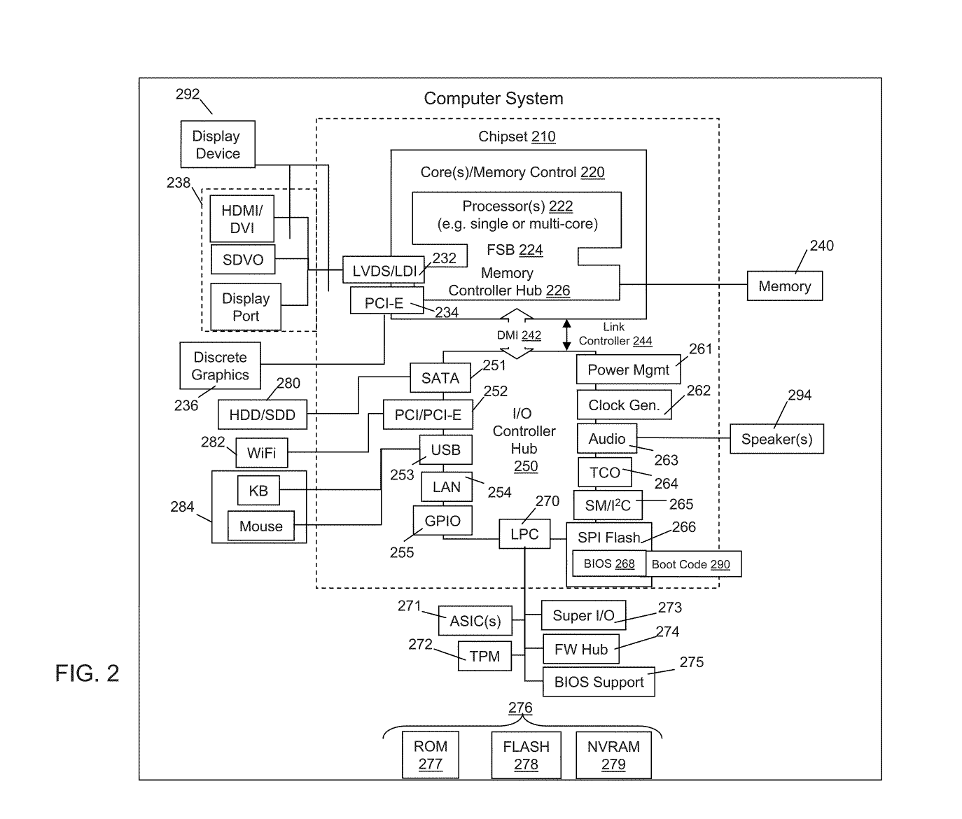

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be included in user devices such as laptop computers, desktop computer, tablet computers, smart phones, etc., that include an image sensor and may be utilized to capture images of a user performing gestures mimicking mouse or other inputs, as further described herein.

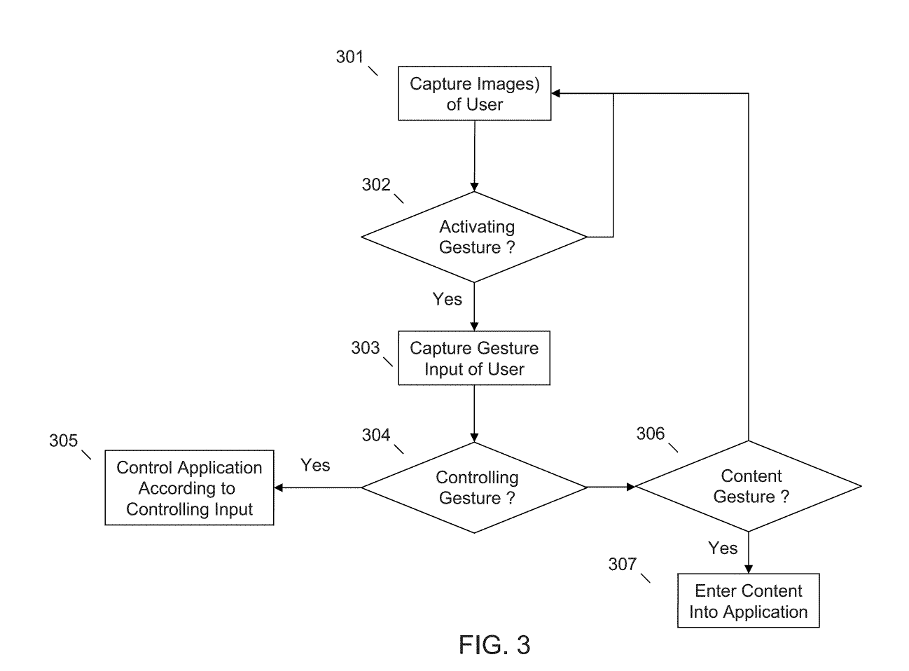

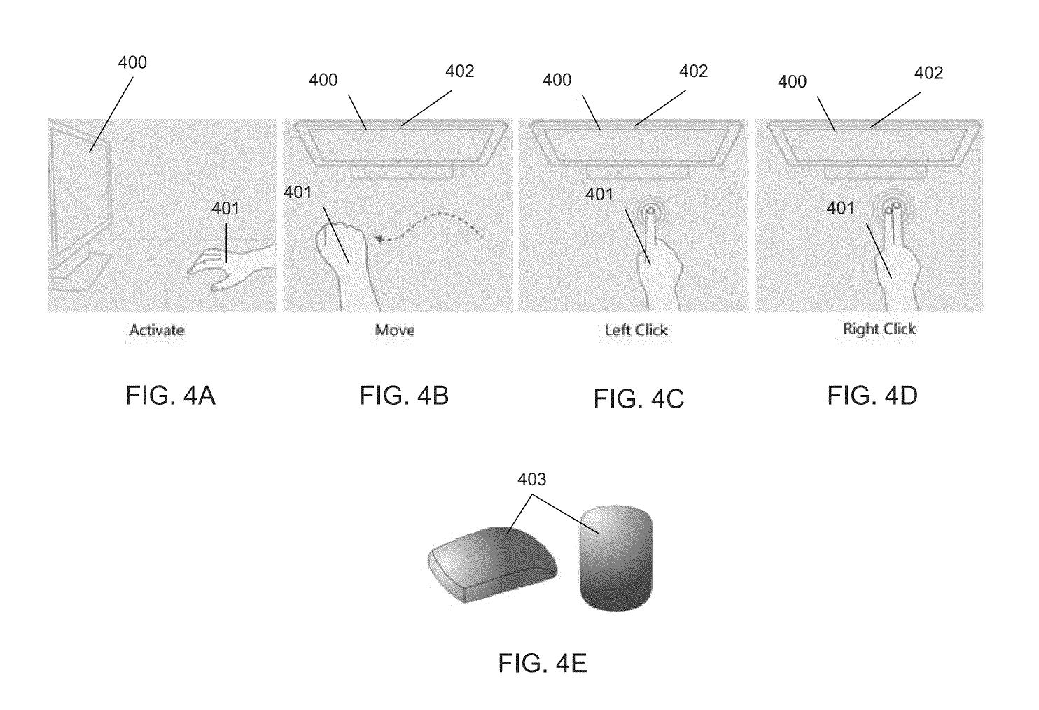

Referring to FIG. 3, an embodiment captures images of a user at 301, e.g., using an integrated camera. At 302, an embodiment determines if an activating gesture has been performed, e.g., a predetermined gesture that signals to the system that the user desires to provide gesture inputs for mimicking mouse controls and/or provide content input using gestures. For example, referring to FIG. 4A, a user may provide an activating gesture input by forming his or her hand into a specific, predetermined shape, for example as if holding a physical mouse as illustrated. This particular gesture is detected by a gesture recognition engine as activating input.

In an embodiment, a physical device 403 may be provided to assist the user in forming a mouse holding shape as an activating gesture to be detected by the system. For example, illustrated in FIG. 4E is an example of such a device 403. This device 403 may not include any electronics and may simply provide a way for the user to appropriately position and orient his or her hand to form the activating gesture. In the alternative, according to an embodiment, the physical device 403 may include a mechanism to assist the user in providing the activating gesture. For example, the physical device 403 may include a communication element, e.g., a near-field communication element that allows it to be detected in proximity to a reader element of the device 400. As another example, the physical device 403 may include printed or otherwise readable indicia such that the camera may detect its location and interpret the presence of the device and/or the user's gesture as an activating signal. Moreover, an embodiment may utilize the detection of the physical device 403 to assist in detecting the nature of controlling and/or content inputs, e.g., the presence of the physical device 403 may assist the gesture recognition engine in tracking the user's gesture movements more accurately.

Referring back to FIG. 3, if an embodiment detects an activating gesture input at 302, an embodiment may thereafter capture further user gesture inputs, e.g., using the camera of the device at 303. An embodiment, having now been activated and accepting user gesture controlling and/or content inputs, may determine at 304 if the detected user gesture inputs are controlling user gestures. If controlling inputs, e.g., moving a cursor on-screen, scrolling, zooming, rotating, etc., are detected, an embodiment may control the application according to the controlling gesture inputs at 305. However, if the user gesture input captures at 303 is not controlling gesture input, an embodiment may determine at 306 the inputs are content gesture inputs, e.g., handwriting input provided by the user, e.g., using a finger tip or a stylus/pen. In the use case where a user provides content input using a stylus/pen, an embodiment may use communication with and/or detectability of the stylus pen to assist in recognizing the content input and entering into a content input mode, e.g., similar to recognizing the activating input described in connection with device 403 of FIG. 4E.

An embodiment may detect a variety of controlling inputs, e.g., by moving his or her hand about a table-top or other surface that is convenient and visible to the camera. For example, illustrated in FIG. 4B is a user moving a closed hand 401 which may be detected by a camera 402 of a device 400 and mapped to control inputs for controlling the movement of an on-screen cursor or pointer, e.g., similar to a physical mouse controlling input.

The shape of the object may be used to further detect and refine the gesture inputs. For example, as illustrated in FIG. 4C, an embodiment may detect a left click input by detecting that the user has extended a single finger. Likewise, as illustrated in FIG. 4D, an embodiment may detect a user has extended more than one finger and map this gesture to another controlling input, e.g., a right click (right mouse button click).

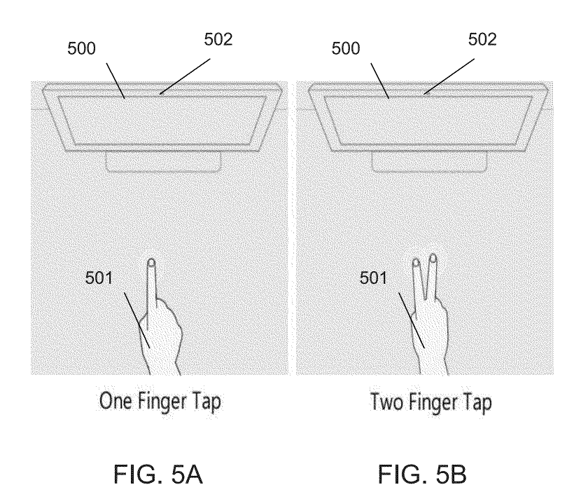

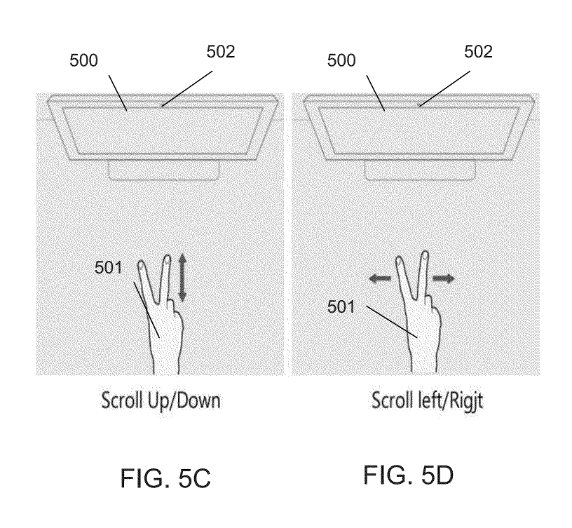

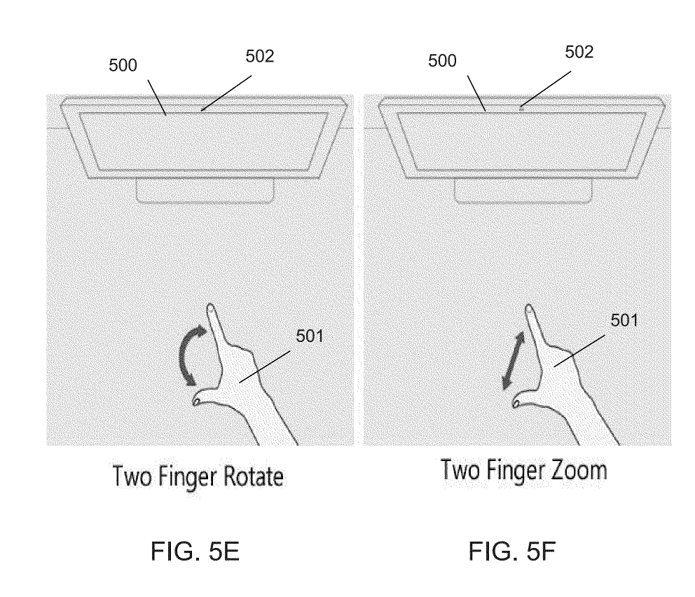

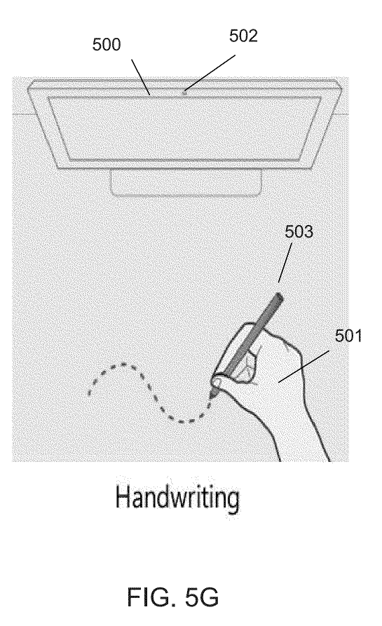

The finger extension gestures may be further refined, as illustrated in FIG. 5(A-F). For example, an embodiment may detect, e.g., using a camera 502 of a device 500, that a user has extended and tapped a single finger of his or her hand 501, e.g., as illustrated in FIG. 5A, and detect a user has extended and tapped two fingers, e.g., as illustrated in FIG. 5B, and map each of these detected gestures to different controlling actions, e.g., single click and double clicks of a mouse button, respectively.

An embodiment may detect a user has performed other gestures, e.g., scrolling of content within the screen. For example, an embodiment may detect a user has extended two fingers and moved his or hand closer or farther away from the device, as illustrated in FIG. 5C, to scroll application screen content up and down. Likewise, an embodiment may detect that a user has extended two fingers and moved his or her hand laterally to scroll left and right, as illustrated in FIG. 5D.

An embodiment may rotate or zoom the displayed content responsive to detecting user gestures, as illustrated in FIGS. 5E and 5F. For example, as illustrated in FIG. 5E, an embodiment may detect that a user has extended fingers and rotated the hand, and thus the extended fingers, and map this input to a rotation of the application content displayed on screen. Similarly, an embodiment may detect a user is performing pinch or zoom motions with his or her hands on the table top and map these inputs to controlling actions zooming the application content appropriately, as illustrated in FIG. 5F.

An embodiment may also permit a user to enter content into an application using table top gestures. For example, as illustrated in FIG. 5G, an embodiment may detect that a user is providing handwriting input to the table top, e.g., with or without detecting the a physical device 503 such as a writing implement, as described herein. Thus, a user may not only control the application using gestures mapped to mouse control inputs, but may additional provide content inputs to the device, e.g., by making writing motions detectable by an image sensor such as a camera 502.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
capturing, using an image sensor of an information handling device, a user gesture input;
determining, using a processor, that the user gesture input comprises an activating gesture input;
capturing, using the image sensor of the information handling device, controlling gesture input of the user;
detecting, within the captured controlling gesturing input, gestures provided on a surface and mimicking use of a mouse; and
controlling an application running on the information handling device based on the controlling gesture input of the user.

2. The method of claim 1, wherein the determining comprises determining that the activating gesture input comprises a user hand forming a specific shape.

3. The method of claim 1, wherein the determining that the activating gesture input comprises a user hand forming a specific shape comprises determining that the specific shape comprises a mouse holding shape.

4. The method of claim 1, wherein:
the detecting further comprises detecting that the controlling gesture input comprises movement of the object used to provide the activating gesture input; and
said controlling an application comprises moving an on-screen cursor according to the movement of the object.

5. The method of claim 1, wherein the detecting comprises detecting that the user gesture input is performed on a substantially planar surface that is substantially perpendicular to the image sensor.

6. The method of claim 1, wherein:
the detecting further comprises detecting that the controlling gesture input comprises finger click gesturing; and
said controlling an application comprises performing an action associated with a mouse button click according to the finger click gesturing.

7. The method of claim 6, wherein said detected finger click gesturing is selected from the group consisting of a single finger click gesturing and a multiple finger click gesturing.

8. The method of claim 1, wherein:
the detecting further comprises detecting that the controlling gesture input comprises finger extension gesturing; and
said controlling an application comprises performing a scrolling action associated with a direction of movement according to the finger extension gesturing.

9. The method of claim 1, wherein:
the detecting further comprises detecting that the controlling gesture input comprises finger extension gesturing; and
said controlling an application comprises performing one or more of a rotate and a zoom action associated with a direction of movement according to the finger extension gesturing.

10. The method of claim 1, wherein:
said detecting, within the captured controlling gesturing input, further comprises detecting content gesture input of the user; and
said controlling an application comprises entering said content into an application running on the information handling device based on the content gesture input of the user.

11. An information handling device, comprising:
an image sensor that captures user gesture input;
a processor operatively coupled to the image sensor;
a memory device that stores instructions accessible to the processor, the instructions being executable by the processor to:
capture, using the image sensor, a user gesture input;
determine that the user gesture input comprises an activating gesture input;
capture controlling gesture input of the user;
detect, within the captured controlling gesturing input, gestures provided on a surface and mimicking use of a mouse; and
control an application running on the information handling device based on the controlling gesture input of the user.

12. The information handling device of claim 11, wherein to determine comprises determining that the activating gesture input comprises a user hand forming a specific shape.

13. The information handling device of claim 11, wherein to determine that the activating gesture input comprises a user hand forming a specific shape comprises determining that the specific shape comprises a mouse holding shape.

14. The information handling device of claim 11, wherein:
to detect further comprises detecting that the controlling gesture input comprises movement of the object used to provide the activating gesture input; and
to control an application comprises moving an on-screen cursor according to the movement of the object.

15. The information handling device of claim 1, wherein to detect comprises detecting that the user gesture input is performed on a substantially planar surface that is substantially perpendicular to the image sensor.

16. The information handling device of claim 11, wherein:
to detect further comprises detecting that the controlling gesture input comprises finger click gesturing; and
to control an application comprises performing an action associated with a mouse button click according to the finger click gesturing.

17. The information handling device of claim 16, wherein said detected finger click gesturing is selected from the group consisting of a single finger click gesturing and a multiple finger click gesturing.

18. The information handling device of claim 11, wherein:
to detect further comprises detecting that the controlling gesture input comprises finger extension gesturing; and
to control an application comprises performing a scrolling action associated with a direction of movement according to the finger extension gesturing.

19. The information handling device of claim 11, wherein:
to detect further comprises detecting that the controlling gesture input comprises finger extension gesturing; and
to control an application comprises performing one or more of a rotate and a zoom action associated with a direction of movement according to the finger extension gesturing.

20. A product, comprising:
a storage device having code stored therewith, the code being executable by a processor and comprising:
code that captures, using an image sensor of an information handling device, a user gesture input;
code that determines, using a processor, that the user gesture input comprises an activating gesture input;
code that captures, using the image sensor of the information handling device, controlling gesture input of the user;
code that detects, within the captured controlling gesturing input, gestures provided on a surface and mimicking use of a mouse; and
code that controls an application running on the information handling device based on the controlling gesture input of the user.
